(19) United States
(12) Patent Application Publication
(10) Pub. No.: US 2018/0152787 A1
(43) Pub. Date: May 31, 2018

(54) ELECTRONIC APPARATUS AND CONTROL METHOD THEREOF

(71) Applicant: Samsung Electronics Co., Ltd., Suwon-si (KR)

(72) Inventors: Sang-mo SON, Suwon-si (KR); Hyunjoo CHUNG, Suwon-si (KR); Byeong-seob KO, Suwon-si (KR); Anant BAIJAL, Suwon-si (KR); Hyeon-sik JEONG, Yongin-si (KR)

(73) Assignee: Samsung Electronics Co., Ltd., Suwon-si (KR)

(21) Appl. No.: 15/806,820

(22) Filed: Nov. 8, 2017

(30) Foreign Application Priority Data
Nov. 29, 2016 (KR) 10-2016-0160693

(51) Int. Cl. H04R 5/02

(52) U.S. Cl. CPC H04R 5/02; H04R 2205/024

(57) ABSTRACT

An electronic apparatus including an audio processor configured to generate an audio output by processing an audio input having at least two channels; and a controller configured to control the audio processor to split the audio input into a first audio component and a second audio component different in a sound image from each other, modify the sound image of the second audio component to a predetermined location for enhancing presence of the audio output, and generate the audio output based on the first audio component having unmodified sound image and the second audio component having modified sound image.

### CROSS-REFERENCE TO RELATED APPLICATIONS

The application claims priority from Korean Patent Application No. 10-2016-0160693 filed on Nov. 29, 2016 in the Korean Intellectual Property Office, the disclosure of which is incorporated herein by reference.

### BACKGROUND

### 1. Field

Apparatuses and methods consistent with the exemplary embodiments relate to an electronic apparatus and a control method thereof and, more particularly, to an electronic apparatus and a control method thereof, which can provide a sound having a larger sound image without audio distortion.

### 2. Description of the Related Art

A television (TV), an audio system and the like electronic apparatus outputs a sound of broadcasting or multimedia content. There are various methods of materializing the sound output of the electronic apparatus. However, a stereo loudspeaker or the like is mostly used for outputting a sound based on an input audio signal. By the way, in a case of a general TV for home use, a space between left and right channel loudspeakers is restricted by the size and width of the TV, and therefore sound is reproduced in a listening environment narrower than an environment required for listening to a standard stereo sound. In other words, a front stereo sound image is so narrow that even a stereo audio signal sounds like a mono sound.

To solve this problem, there has been disclosed a stereo enhancement system for enlarging a sound image by applying a head related transfer function (HRTF) to a received multi-channel sound (U.S. Pat. No. 7,801,317 B2).

According to the related art, the HRTF is applied even when a sound image of a 2-channel stereo sound source is positioned at the center, and therefore an unnecessary distortion of a tone is caused. Further, the related art is insufficient to reproduce natural presence since a virtual loudspeaker is limited to 2 channels. Besides, the related art has a problem of having no regard for a path difference caused when a plurality of loudspeakers are arranged left and right in accordance with frequency bands.

### SUMMARY

An aspect of one or more exemplary embodiments is to provide an electronic apparatus and a control method thereof, in which a sound having a larger sound image is provided without a distortion.

According to an aspect of an exemplary embodiment, there is provided an electronic apparatus including: an audio processor configured to generate an audio output by processing an audio input having at least two channels; and a controller configured to control the audio processor to split the audio input into a first audio component and a second audio component different in a sound image from each other, modify the sound image of the second audio component to a predetermined location, and generate the audio output based on the first audio component and the modified second audio component.

Thus, a sound having a larger sound image is provided without distortion.

The first audio component may be concerned with a central sound image, and the second audio component may be concerned with an ambient sound image except the central sound image.

Thus, a process for modifying a sound image is skipped with regard to the first audio component, a sound image of which is located at the center, and it is possible to decrease a distortion of an audio output.

The controller may further configured to control the audio processor to split the second audio component into a plurality of components.

Thus, it is possible to provide a sound having a larger sound image.

The electronic apparatus may further include a loudspeaker configured to output a sound based on the generated audio output.

Thus, such a generated sound is output.

The controller may further configured to control the audio processor to modify the sound image of the second audio component to a predetermined location based on a position of the loudspeaker.

Thus, a sound image is more accurately modified by taking an actual sound output position.

The controller may further configured to control the audio processor to perform a process for cancelling crosstalk of the sound output through the loudspeaker with regard to the second audio component having the sound image modified to the predetermined location.

Thus, it is possible to decrease interference between channels of an audio output.

The loudspeaker may include a plurality of loudspeakers that are arranged to be spaced apart at a predetermined distance from each other based on a frequency band of the audio input, and the controller may further configured to control the audio processor to modify the sound image of the second audio component to a predetermined location based on the predetermined distance and the arranged position of each loudspeaker.

Thus, it is possible to more accurately modify a sound image of a sound by taking each position of a plurality of loudspeakers.

According to an aspect of an exemplary embodiment, there is provided a method of controlling an electronic apparatus, the method comprising: generating an audio output by processing an audio input having at least two channels; splitting the audio input into a first audio component and a second audio component different in a sound image from each other; modifying the sound image of the second audio component to a predetermined location; and generating the audio output based on the first audio component and the modified second audio component.

Thus, it is possible to provide a sound having a larger sound image without a distortion.

The first audio component may be concerned with a central sound image, and the second audio component may be concerned with an ambient sound image except the central sound image.

Thus, a process for modifying a sound image is skipped with regard to the first audio component, a sound image of which is located at the center, and it is possible to decrease a distortion of an audio output.

The splitting the audio input may include splitting the second audio component into a plurality of components.

Thus, it is possible to provide a sound having a larger sound image.

The method may further include outputting a sound based on the generated audio output through a loudspeaker.

Thus, such a generated sound is output.

The modifying the sound image to a predetermined location may include modifying the sound image of the second audio component to the predetermined location based on a position of the loudspeaker.

Thus, a sound image is more accurately modified by taking an actual sound output position.

The method may further include performing a process for cancelling crosstalk of the sound output through the loudspeaker with regard to the second audio component having the sound image modified to the predetermined location.

Thus, it is possible to decrease interference between channels of an audio output.

The modifying the sound image to a predetermined position may include arranging a plurality of loudspeakers to be spaced apart at a predetermined distance from each other based on a frequency band of the audio input; and modifying the sound image of the second audio component to a predetermined location based on the predetermined distance and the arranged position of each loudspeaker.

Thus, it is possible to more accurately modify a sound image of a sound by taking each position of a plurality of loudspeakers.

### BRIEF DESCRIPTION OF THE DRAWINGS

The above and/or the aspects will become apparent and more readily appreciated from the following description of exemplary embodiments, taken in conjunction with the accompanying drawings, in which:

FIG. 1 illustrates an electronic apparatus according to an exemplary embodiment;

FIG. 2 is a block diagram of the electronic apparatus according to an exemplary embodiment;

FIG. 3 is a block diagram of an audio processor according to an exemplary embodiment;

FIG. 4 is a block diagram of a signal splitter according to an exemplary embodiment;

FIG. 5 is a block diagram of a binaural synthesizer according to an exemplary embodiment;

FIG. 6 illustrates a sound image enlarged by virtual loudspeakers according to an exemplary embodiment;

FIG. 7 is a block diagram of a crosstalk canceler according to an exemplary embodiment;

FIG. 8 is a block diagram of a signal splitter for splitting a second audio component into a plurality of components according to another exemplary embodiment;

FIG. 9 illustrates a binaural synthesizer corresponding to the plurality of components split from the second audio component according to another exemplary embodiment;

FIG. 10 illustrates a plurality of virtual loudspeakers separated according to another exemplary embodiment;

FIG. 11 illustrates an electronic apparatus according to another exemplary embodiment, in which a plurality of loudspeakers spaced apart from each other in a horizontal direction;

FIG. 12 is a block diagram of an audio processor for a plurality of loudspeakers according to another exemplary embodiment;

FIG. 13 is a control flowchart according to an exemplary embodiment;

FIG. 14 illustrates improvement in a distortion of an audio output according to an exemplary embodiment;

FIG. 15 illustrates improvement in a distortion of an audio output according to an exemplary embodiment, when a test signal is panned from a side to a center;

FIG. 16 is a block diagram of an electronic apparatus according to another exemplary embodiment;

FIG. 17 illustrates an operation of the electronic apparatus according to an exemplary embodiment;

FIG. 18 illustrates that an angle of a sound source and the number of virtual loudspeakers set in FIG. 17 according to an exemplary embodiment; and

FIG. 19 is a block diagram of an electronic apparatus according to another exemplary embodiment.

### DETAILED DESCRIPTION

Below, exemplary embodiments will be described in detail with reference to accompanying drawings. In the following descriptions referring to the accompanying drawings, like numerals refer to like elements having substantially the same function.

In the description of the exemplary embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the idea of the embodiments.

The present concept to be described in the following exemplary embodiments may be applied to an electronic apparatus for outputting a sound of content. As an example of the electronic apparatus, there will be described a display apparatus for displaying an image of content while outputting a sound, but the present concept is not limited thereto. Alternatively, the present concept may be applied to various electronic apparatuses such as an audio system, an audio/video (A/V) apparatus and the like capable of outputting a sound.

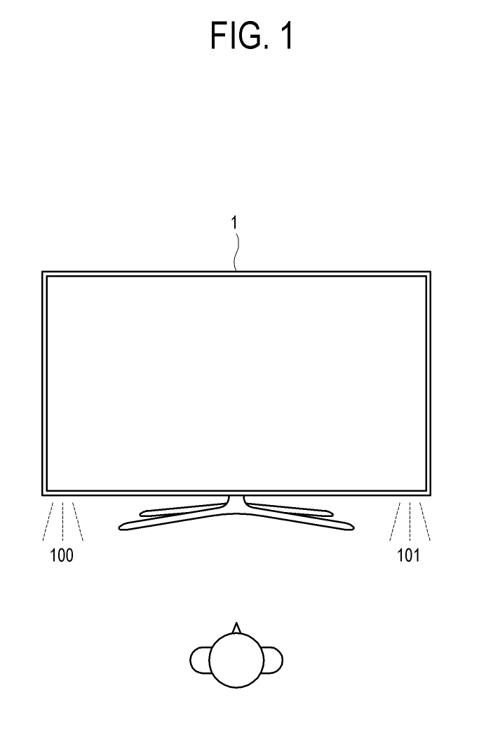

FIG. 1 illustrates an electronic apparatus according to an exemplary embodiment. An electronic apparatus 1 offers content with a sound to a user. As shown in FIG. 1, the electronic apparatus 1 according to an exemplary embodiment may be materialized by a television (TV) or the like display apparatus by way of example. According to another exemplary embodiment, the electronic apparatus 1 may be materialized by various electronic apparatuses such as a tablet computer, a mobile phone, a multimedia player, an electronic frame, a digital signage, a large format display (LFD), a set-top box, an MP3 player, a digital versatile disc (DVD) player, a Blu-ray player, a radio device, an A/V receiver, a loudspeaker system, an audio system for a vehicle, and the like capable of outputting a sound.

The electronic apparatus 1 processes a content signal received from the outside so as to provide content. The content signal may include a broadcasting signal received from a broadcasting station, a data packet signal received through a network, or a signal received from a multimedia device connected to the electronic apparatus 1. Alternatively, the content may be generated from data stored in the electronic apparatus 1.

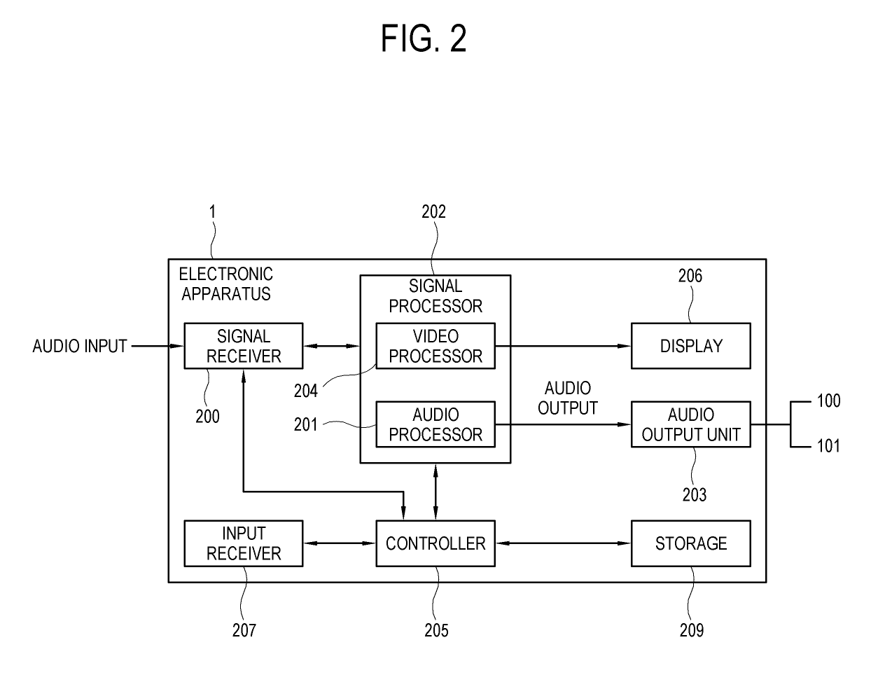

The content includes sounds 100 and 101. In addition, the content may further include an image or appended information besides the sounds 100 and 101. The electronic apparatus 1 may use loudspeakers connected to a built-in audio output unit (refer to ‘203’ of FIG. 2) so as to output the sounds 100 and 101. Alternatively, the electronic apparatus 1 may use a headset connected though the audio output unit 203 so as to output the sounds 100 and 101.

The electronic apparatus 1 according to an exemplary embodiment modifies a sound image to more enhance the presence of the reproduced sounds 100 and 101 output from the audio output unit 203 or the loudspeaker. The sound image refers to a location of a virtual sound source to be psychoacoustically perceived by a listener with the sounds 100 and 101 output from the electronic apparatus 1. To modify the sound image, a measured level at a predetermined location and an HRTF calculated based on the loudspeaker of the electronic apparatus 1 are used.

The electronic apparatus 1 splits an input audio signal into a first audio component and a second audio component, which are different in the sound image from each other, in order to move the sound image of the sounds 100 and 101 to a desired location without distortion. The first audio component may be concerned with a central sound image, and the second audio component may be concerned with an ambient sound image except the center sound image. If the HRTF is applied to the first audio component, unnecessary distortion may occur since the sound image is formed at the center. To enhance the presence, the electronic apparatus 1 modifies the sound image of the second audio component split from the audio input, and synthesizes the second audio component having the modified sound image with the first audio component having the unmodified sound image, thereby generating an audio output.

Below, details of the electronic apparatus 1 according to an exemplary embodiment will be described.

FIG. 2 is a block diagram of the electronic apparatus according to an exemplary embodiment. The electronic apparatus 1 includes a signal processor 202 and a controller 205. In addition, the electronic apparatus 1 may further include at least one among a signal receiver 200, an input receiver 207, a display 206, an audio output unit 203, a storage 209 and a communicator. The elements of the electronic apparatus 1 shown in FIG. 2 are given just by way of example, and the electronic apparatus 1 according to an exemplary embodiment may include another element besides the elements shown in FIG. 2. For example, the electronic apparatus 1 according to an exemplary embodiment may include another element in addition to the elements shown in FIG. 2 or may exclude one element from the elements shown in FIG. 2.

The signal receiver 200 receives a content signal including a video signal and an audio signal from the outside. The content signal may be received in the form of a transport stream. As an example of the content signal, the signal receiver 200 may receive a broadcast signal of one channel selected by a user among a plurality of channels. The signal receiver 200 may receive an image signal from an image processing device such as a set-top box, a digital versatile disc (DVD) player, a personal computer (PC), etc., a mobile device such as a smart phone, etc., or a server through the Internet. The audio signal received in the signal receiver 200 may include stereo signals corresponding to a left channel and a right channel, multi-channel audio signals corresponding to a plurality of channels.

The display 206 displays an image based on a video signal processed by the signal processor 202. There are no limits to the type of display 206. For example, the display 206 may be materialized by various display types such as liquid crystal, plasma, a light-emitting diode (LED), an organic light-emitting diode (OLED), a surface-conduction electron-emitter, a carbon nano-tube (CNT), nano-crystal, etc.

In case of a liquid crystal display (LCD), the display 206 includes an LCD panel, a backlight unit for illuminating the LCD panel, a panel driving substrate for driving the LCD panel, etc. Alternatively, the display 206 may be materialized by a self-emissive OLED without the backlight unit.

The signal processor 202 processes the content signal received in the signal receiver 200 and outputs an image and a sound through the display 206 and the audio output unit 203, respectively. The signal processor 202 includes a video processor 204 for processing an image and an audio processor 201 for processing a sound.

The video processor 204 performs a video processing process with regard to a video signal extracted from a transport stream received in the signal receiver 200 and outputs the processed video signal to the display 206 so that the display 206 can display an image. The video processing process performed in the video processor 204 may for example include demultiplexing for splitting an input transport stream into sub-streams such as a video signal, an audio signal and appended data; de-interlacing for converting an interlaced video signal into a progressive video signal; scaling for changing a resolution of a video signal; noise reduction, detail enhancement and frame refresh rate for improving image quality; and so forth.

The audio processor 201 performs various processes with regard to an audio signal. If a transport stream is received in the signal receiver 200, the audio processor 201 applies an audio process to an audio signal extracted from the transport stream and outputs the processed audio signal through the audio output unit 203, thereby providing a sound to a user.

According to an exemplary embodiment, the audio processor 201 splits an audio input into a first audio component having a central sound image and a second audio component having an ambient sound image except the central sound image. The audio processor 201 modifies the sound image of the second audio component, cancels crosstalk, generate an audio output by synthesizing the processed second audio component with the first audio component, thereby transmitting the audio output to the audio output unit 203. Detailed structures and operations of the audio processor 201 will be described later.

The audio output unit 203 outputs a sound based on the audio output received from the audio processor 201. The audio output unit 203 may be for example provided to output a sound having an audible frequency of 20 Hz to 20 kHz. The audio output unit 203 may be variously placed with respect to the display 206 in consideration of a processable audio channel and an output frequency. For example, the audio out units 203 may be placed at left and right edges of the display 206. The audio output unit 203 may include at least one of a sub-woofer, a mid-woofer, a mid-range loudspeaker and a tweeter loudspeaker in accordance with frequency bands of the audio output.

The input receiver 207 receives a user's user and transmits it to the controller 205. The input receiver 207 may be variously materialized according to a user's input methods. For example, the input receiver 207 may include a menu button installed on an outer side of the electronic apparatus 1; a remote controller signal receiver for receiving a remote control signal corresponding to a user's input from a remote controller; a touch input receiver provided on the display 206 and receiving a user's touch input; a camera for sensing a user's gesture input; a microphone for receiving a user's voice input; a communicator for communicating with an external apparatus and receiving a user's input from the external apparatus; etc.

The storage 209 stores a variety of data therein in the electronic apparatus 1. The storage 209 may be materialized by a nonvolatile memory (writable read only memory (ROM)) in which data is retained even though the electronic apparatus 1 is powered off, and changes are reflected. That is, the storage 209 may include one of a flash memory, an erasable and programmable read only memory (EPROM) or an electrically erasable programmable read only memory (EEPROM). The storage 209 may further include a volatile memory such as a dynamic random access memory (DRAM) or static random access memory (SRAM) of which a reading or writing speed for the electronic apparatus 1 is higher than that of the nonvolatile memory.

The communicator is provided to communicate with the external apparatus. The communicator is materialized in various forms according to the types of electronic apparatus 1. For example, the communicator includes a connection unit for wired communication, and the connection unit may receive/transmit a signal/data based on a high definition multimedia interface (HDMI), HDMI-consumer electronics control (CEC), a universal serial bus (USB), component and the like standards, and include at least one connector or terminal corresponding to the standards. The communicator may perform the wired communication with a plurality of servers through a wired local area network (LAN).

The communicator may include various elements corresponding to the design of the electronic apparatus 1 as well as the connection unit including the connector or the terminal for the wired connection. For example, the communicator may include a radio frequency (RF) circuit for transmitting and receiving an RF signal to perform wireless communication with the external apparatus, and implement one or more communication among wireless fidelity (W-Fi), Bluetooth, Zigbee, ultra-wide band (UWB), wireless USB, and near field communication (NFC).

The controller 205 performs control to operate general elements of the electronic apparatus 1. The controller 205 may include a control program for implementing the control, a nonvolatile memory in which the control program is installed, a volatile memory in which the installed control program is at least partially loaded, and at least one microprocessor or central processing unit (CPU) for executing the loaded control program. The control program may include a program(s) given in the form of at least one of a basic input/output system (BIOS), a device driver, an operating system (OS), a firmware, a platform, and an application program. According to an exemplary embodiment, the application program may be previously installed or stored in the electronic apparatus 1 when the electronic apparatus 1 is manufactured, or may be installed in the electronic apparatus 1 based on data of the application program received from the outside in the future when it is used. The data of the application program may be for example downloaded from an external server such as an application market into the electronic apparatus 1.

According to an exemplary embodiment, the controller 205 controls the audio processor 201 to modify the ambient sound image of the second audio component from the audio input except the central sound, and synthesize the second audio component having the modified sound image with the first audio component, thereby generating an output sound.

Further, the controller 205 controls the audio processor 201 to cancel the crosstalk of the sound output through the loudspeaker, with regard to the second audio component having the modified sound image.

In addition, if the communicator is used to transmit the output sound to the external apparatus, the controller 205 may selectively skip canceling the crosstalk based on whether the external apparatus is a headset or an external loudspeaker.

Below, details structures and functions of the audio processor 201 will be described with reference to accompanying drawings.

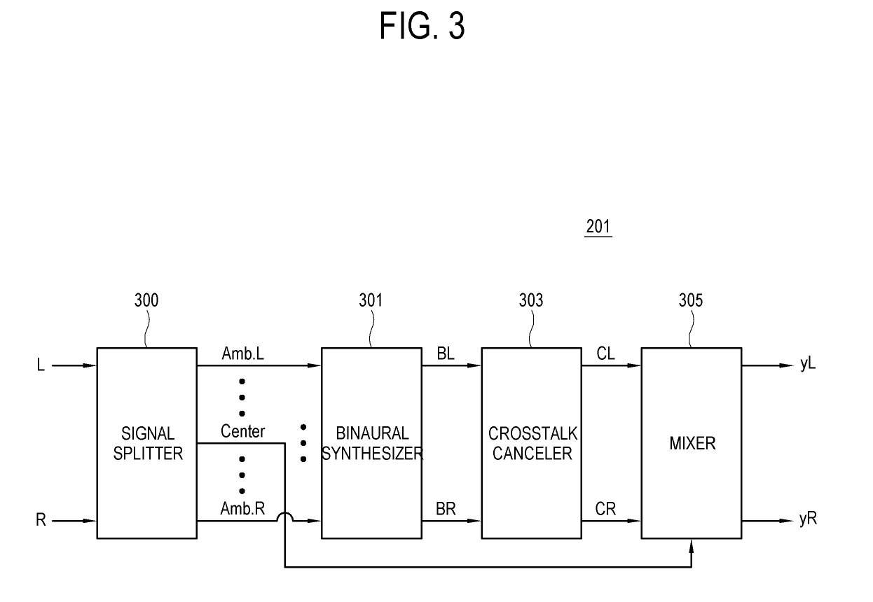

FIG. 3 is a block diagram of an audio processor according to an exemplary embodiment. The audio processor 201 applies an audio process to an audio input to thereby generate an audio output of which a sound image is modified and crosstalk is canceled. To this end, the audio processor 201 includes a signal splitter 300, a binaural synthesizer 301, a crosstalk canceler 303 and a mixer 305.

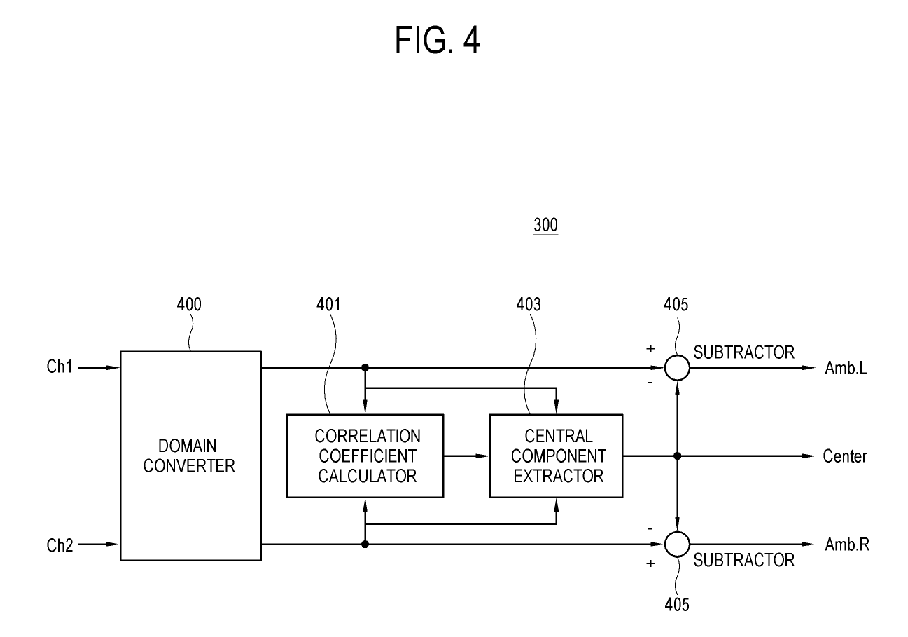

FIG. 4 is a block diagram of a signal splitter according to an exemplary embodiment. The signal splitter 300 splits an audio input into a first audio component Center and second audio components Amb L and Amb R. For example, the first audio component Center, of which the sound image is located at the center, may be an audio component such as a line or narration of an actor in content such as a movie or a drama. On the other hand, the second audio components Amb L and Amb R, of which the sound image is located in the background except the center, may be an audio component such as background music, ambient sounds. If the sound image is located at the center, there are no needs of modifying the sound image or canceling the crosstalk. Therefore, the audio processor 201 separates the first audio component Center having the central sound image from the audio input and skips the following processes for the first audio component Center.

The signal splitter 300 includes a domain converter 400, a correlation coefficient calculator 401, a central component extractor 403 and a subtractor 405.

The domain converter 400 receives an audio signal concerning a first channel and a second channel and converts a domain of the audio signal. The domain converter 400 uses fast Fourier transform (FFT) or the like algorithm to convert a domain of a stereo signal into a frequency domain.

The correlation coefficient calculator 401 calculates a correlation coefficient based on an audio signal converted to have a frequency domain by the domain converter 400. The correlation coefficient calculator 401 obtains a first coefficient showing coherence between two channels concerned with the audio signal and a second coefficient showing similarity between the two channels, and then obtains a correlation coefficient based on the first coefficient and the second coefficient. The correlation coefficient calculator 401 transmits the calculated correlation coefficient to the central component extractor 403.

The central component extractor 403 extracts the first audio component Center from the audio signal by using the correlation coefficient and the audio signal. The central component extractor 403 obtains an arithmetic mean of the audio signal and multiplies the arithmetic mean by the correlation coefficient to thereby generate the first audio component Center.

The subtractor 405 obtains a difference between the audio signal and the first audio component Center. The subtractor 405 generates a left ambient audio signal Amb L by subtracting the first audio component (Center) from the first audio channel CH 1 having a left component, and generates a right ambient audio signal Amb R by subtracting the first audio component (Center) from the second audio channel CH 2 having a right component.

In the accompanying drawings and the foregoing descriptions, the input audio signal is a 2-channel signal, but not limited thereto. Alternatively, the input audio signal may be a 5.1 or higher multi-channel audio signal. If the audio input is split into the first audio component Center and the second audio components Amb L and Amb R and then received, the signal splitter 300 does not apply a split to the received audio input, and transmits the second audio components Amb L and Amb R except the first audio component Center to the binaural synthesizer 301 and the crosstalk canceler 303.

If the audio input includes left/right and central channels, the central channel may include a part of the first audio component and a part of the second audio component in order to naturally generate a front sound image. In this case, channels including the central channel and the left/right channels may be to the signal splitter 300 so as to be split into the first audio component Center and the second audio components Amb L and Amb R.

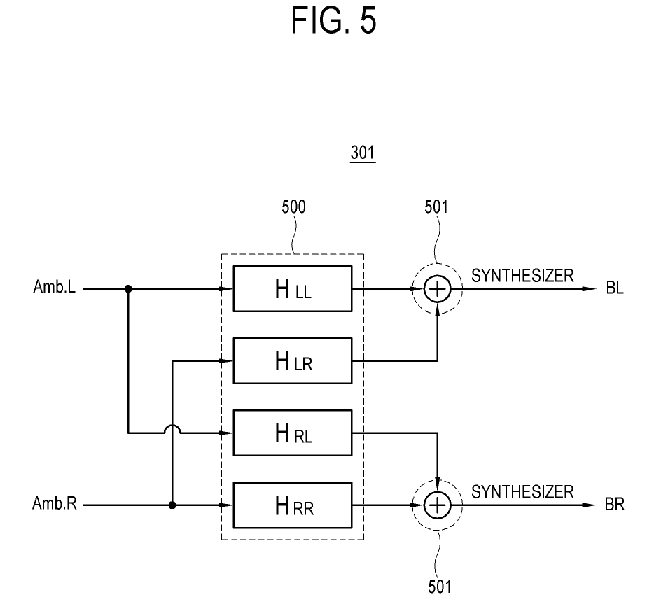

FIG. 5 is a block diagram of the binaural synthesizer for performing binaural synthesis with regard to the second audio components Amb L and Amb R including one pair of stereo channels according to an exemplary embodiment. The binaural synthesizer 301 receives the second audio components Amb L and Amb R among the first audio component Center and the second audio components Amb L and Amb R, which are split by the signal splitter 300 or input as they are split, and applies the audio process to them so as to modify the sound image with respect to a location of a virtual loudspeaker. The binaural synthesizer 301 includes a head related transfer function (HRTF) 500 and a synthesizer 501 for synthesizing the audio components subjected to the HRTF. The HRTF refers to an acoustic transfer function between a sound source and an eardrum. Such an HRTF involves information about a time difference between two ears, a level difference between two ears, and a spatial characteristic including a shape of an earflap where a sound is transmitted. In particular, the HRTF includes information about an earflap having a decisive effect on upper and lower sound image fixing, and the information is obtained by measurement since modeling the earflap is not easy. The HRTF information may be based on data about Knowles electronics mannequin for acoustic research (KEMAR) dummy head measured in a Massachusetts institute of technology (MIT) media lab. The HRTF may be measured by a sinusoidal-wave vibration method, a white noise vibration method, an impulse response method using a maximum length sequence (MLS), etc. To measure the HRTF, the sinusoidal-wave vibration method controls a sinusoidal-wave input signal of a loudspeaker to keep a constant sound pressure at a measurement position under a free sound field (e.g. in an anechoic room), and then records an audio response of an ear when the loudspeaker is vibrated with a signal recorded from installing a head dummy. To measure the HRTF, the white noise vibration method measures an audio response to white noise generated by a noise generator and obtains a frequency response function. To measure the HRTF, the method using the MLS generates an MLS signal, vibrates a loudspeaker with the input of the generated MLS signal, and obtains an impulse response function by measuring a correlation function between the input signal and the audio response of the head dummy. Therefore, the reproduction based on the foregoing characteristic modeling makes a listener feel as if the reproduction occurs at an intended specific position even though an actual loudspeaker is not located at that position. In case of 2-channel HRTF, the HRTF 500 is for example calculated based on a measurement level measured from standard stereo loudspeakers opened left and right from a center at an angle of 30 degrees and the positions of the loudspeakers provided in the electronic apparatus 1, but not limited thereto. The binaural synthesizer 301 applies convolution between the second audio components Amb L and Amb R split from the audio input and HLL, HLR, HRL and HRR of the transfer function 500. The binaural synthesizer 301 applies the HRTF 500 to a second audio component of each channel. More specifically, the binaural synthesizer 301 applies HLL and HRL to the left ambient audio component Amb L of the second audio components Amb L and Amb R, and applies HRR and HLR to the right ambient audio components Amb R. Then, the synthesizer 501 synthesizes the audio components subjected to HLL and HLR to generate a left binaural synthesized audio component BL, and synthesizes the audio components subjected to HRR and HRL to generate a right binaural synthesized audio component BR. Thus, a user may feel as if a virtual sound source is located at a different place from the actual loudspeakers. The respective audio components subjected to the transfer function 500 are synthesized in the synthesizer 501 and then output.

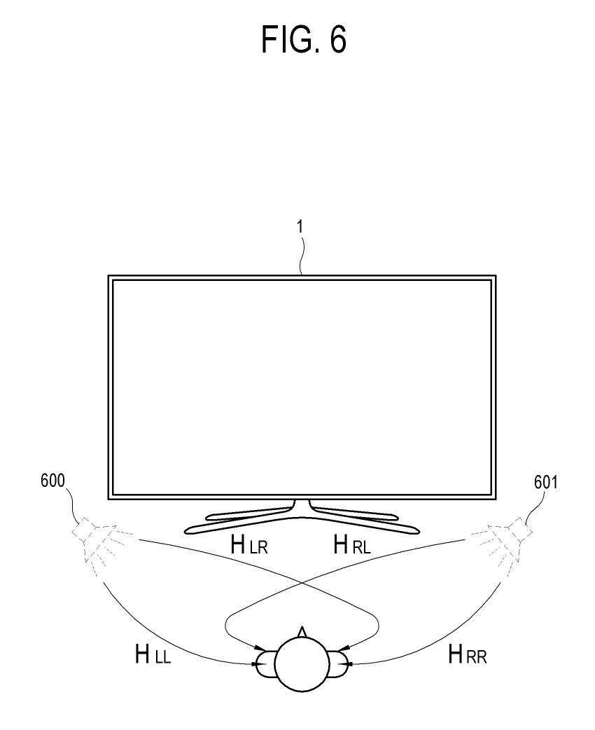

FIG. 6 shows a relationship between a listener and a virtual loudspeaker formed by the binaural synthesis of applying a HRTF filter to a second audio component according to an exemplary embodiment. As the HRTF 500 is applied, a listener feels as if sounds are output from virtual loudspeakers 600 and 601 opened from a center at an angle of 30 degrees.

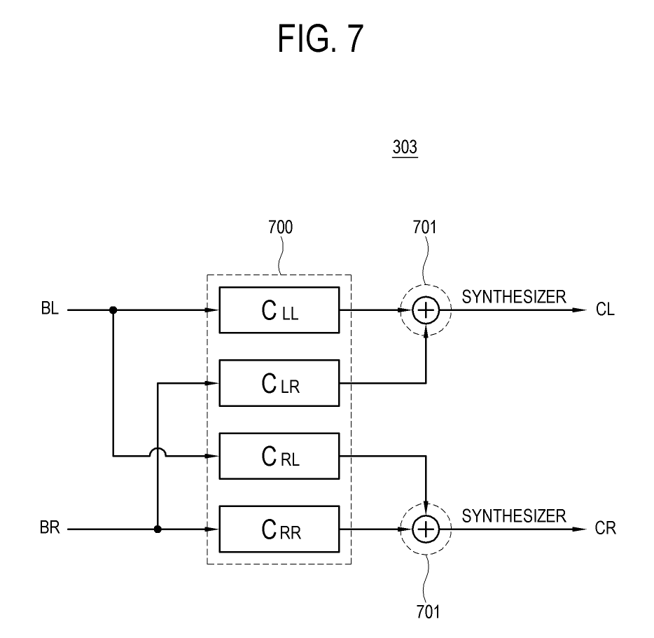

FIG. 7 is a block diagram of a crosstalk canceler according to an exemplary embodiment. The crosstalk canceler 303 performs a process to cancel crosstalk, which may be generated in the audio output, from the binaural synthesized audio components BL and BR output from the binaural synthesizer 301. The crosstalk hinders a listener from listening to a sound of one channel (e.g. L) as it transmitted to a left ear is mixed with another sound (R). The crosstalk canceler 303 cancels the crosstalk by applying a crosstalk coefficient 700 to the binaural synthesized audio components BL and BR. The crosstalk coefficient 700 may be determined by an inverse matrix of the HRTF 500. Thus, the listener cannot hear the sound of one channel output from the left (right) loudspeaker through his right (left) ear. The second audio components CL and CR subjected to the crosstalk canceling are transmitted to the mixer 305.

The mixer 305 mixes the second audio components CL and CR subjected to the crosstalk canceling with the first audio component, thereby generating audio outputs yL and yR.

According to another exemplary embodiment, if the electronic apparatus 1 transmits an audio output signal to a headset or the like external audio output device causing no crosstalk through the communicator, the controller 205 skips the crosstalk canceling process, and mixes the second audio component having a modified sound image and the first audio component having the unmodified sound image, thereby generating the audio output.

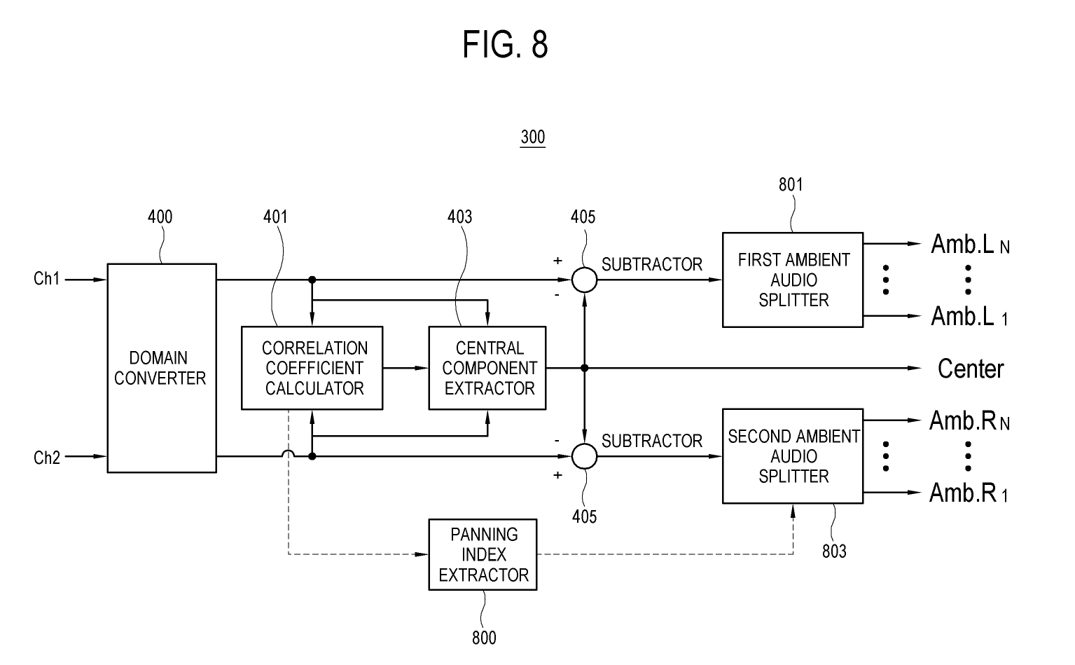

In the foregoing exemplary embodiment, the second audio component split by the signal splitter 300 includes the left ambient audio component Amb L and the right ambient audio component Amb R. However, the present inventive is not limited thereto. According to another exemplary embodiment, the signal splitter 300 may split the second audio component into more split components, or the audio input including more split second audio components may be received from the outside, details of which will be described below with reference to FIG. 8.

FIG. 8 is a block diagram of a signal splitter for splitting a second audio component into a plurality of components according to another exemplary embodiment. The signal splitter 300 further includes a panning index extractor 800 and first and second ambient audio splitters 801 and 803 in order to separate three or more signals from the audio input in accordance with left/right panning angles. If the second audio component has already been split into a plurality of components and then received, the signal splitter 300 may not split the second audio component any more or may additionally split the second audio component.

The panning index extractor 800 extracts a panning index from a correlation coefficient calculated by the correlation coefficient calculator 401. More specifically, the panning index extractor 800 calculates how much a sound source of a sound is panned based on a ratio between the respective channels of the received audio inputs L and R, and extracts a panning index corresponding to a panned degree. According to another exemplary embodiment, a broadcasting signal or the like content signal received in the signal receiver 200 may include information about a panning index of a sound.

The first and second ambient audio splitters 801 and 803 divides the second audio component into more split components in accordance with panning degrees based on the extracted panning index. The plurality of split left ambient audio components AmbL₁˜AmbL_{N} and the plurality of split right ambient audio components AmbR1˜AmbRN respective have levels corresponding to the extracted panning indexes.

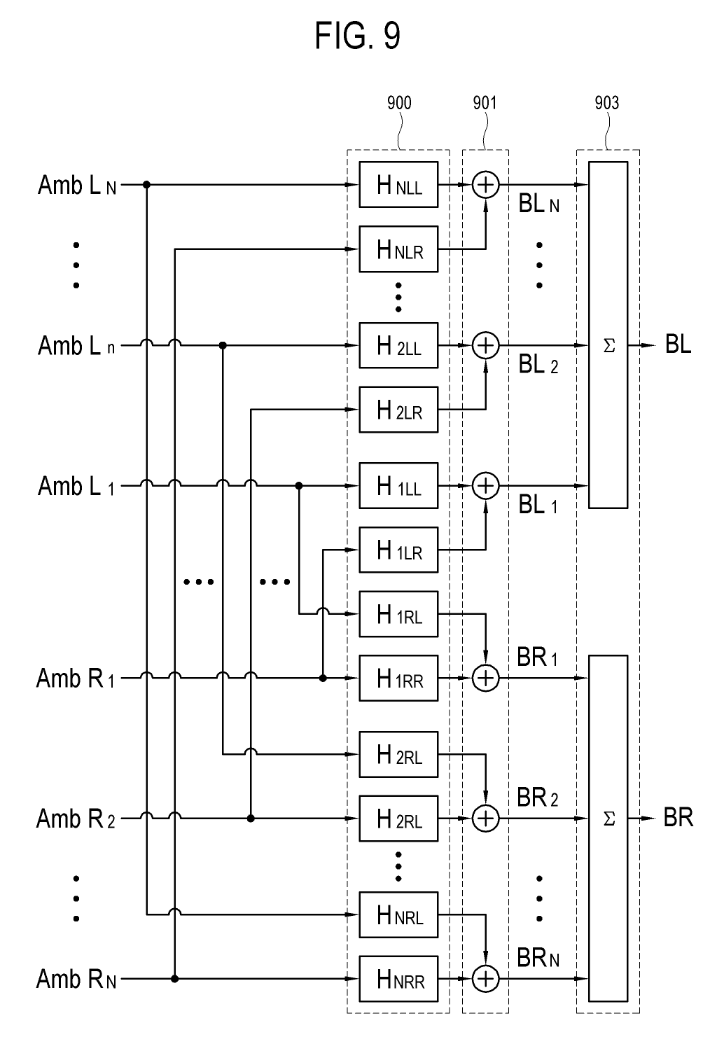

FIG. 9 is a detailed block diagram of the binaural synthesizer 301 for applying an HRTF 900 to 2N channels. The binaural synthesizer 301 applies a transfer function 900, which is designed using the HRTF measured at more positions than those for the signal splitter 300, to a plurality of split second audio components AmbL₁˜AmbL_{N} and AmbR₁˜AmbR_{N}. For example, a transfer function for a virtual loudspeaker closest to the center is defined as ‘H₁’, and a transfer function for a virtual speaker farthest from the center is defined as ‘H_{N}’. The synthesizers 901 and 903 synthesize the audio components passed through the transfer function 900 so as to generate a left binaural synthesized sound BL and a right binaural synthesized sound BR.

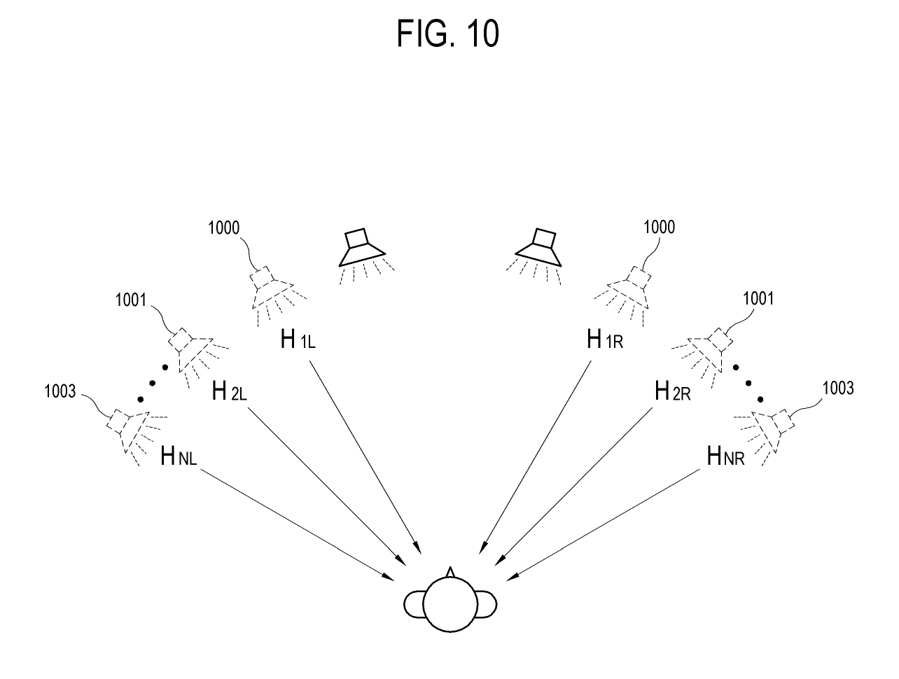

FIG. 10 illustrates a relationship between a listener and a plurality of virtual loudspeakers 1000, 1001 and 1003 formed by binaural synthesis of applying a plurality of HRTfs to a plurality of split second audio components according to another exemplary embodiment. The electronic apparatus 1 more naturally reproduces a sound through more virtual loudspeakers 1000, 1001 and 1003.

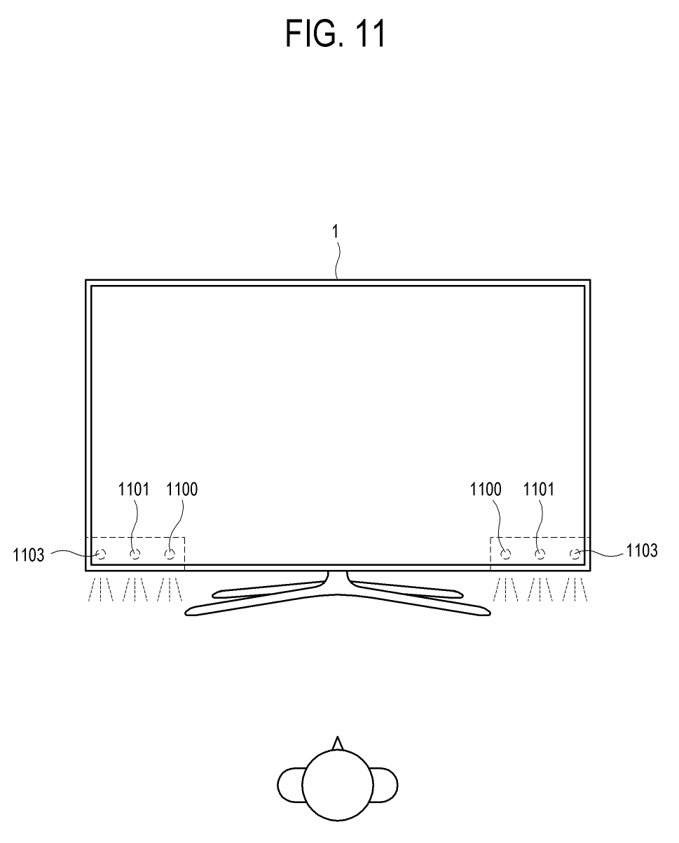

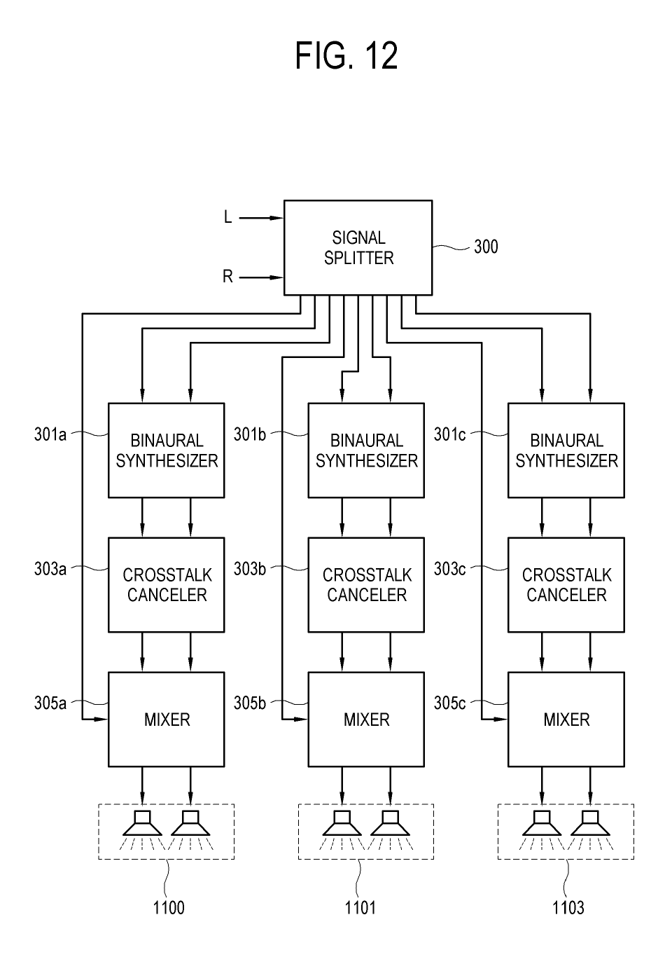

FIG. 11 illustrates an electronic apparatus according to another exemplary embodiment, and FIG. 12 is a block diagram of an audio processor for a plurality of loudspeakers. The audio output unit 203 may include a plurality of loudspeakers 1100, 1101 and 1103 corresponding to a plurality of frequency bands in accordance with frequency bands of an audio output. If the plurality of loudspeakers 1100, 1101 and 1103 are arranged up and down, i.e. in a vertical direction, it does not make much difference in the HRTF among the loudspeakers since there is little path difference of the audio output. On the other hand, if the plurality of loudspeakers 1100, 1101 and 1103 are arranged left and right, i.e. in a horizontal direction, there is a path difference from each of the loudspeakers 1100, 1101 and 1103 to a listener since a limited space of the electronic apparatus 1. To solve this, the audio processor 201 according to another exemplary embodiment includes the signal splitter 300 for splitting the first audio component and the second audio component according to the frequency bands, a plurality of binaural synthesizers 301 and a plurality of crosstalk cancelers 303 for applying the binaural synthesis and the crosstalk canceling to the second audio component split according to the frequency bands, and a plurality of mixers 305.

The plurality of binaural synthesizers 301 and the plurality of crosstalk cancelers 303 respectively apply distances between the plurality of loudspeakers 1100, 1101 and 1103, locations where the respective loudspeakers 1100, 1101 and 1103 are arranged, and HRTF coefficients and crosstalk filtering coefficients measured in at least one location to the second audio component split from the audio input.

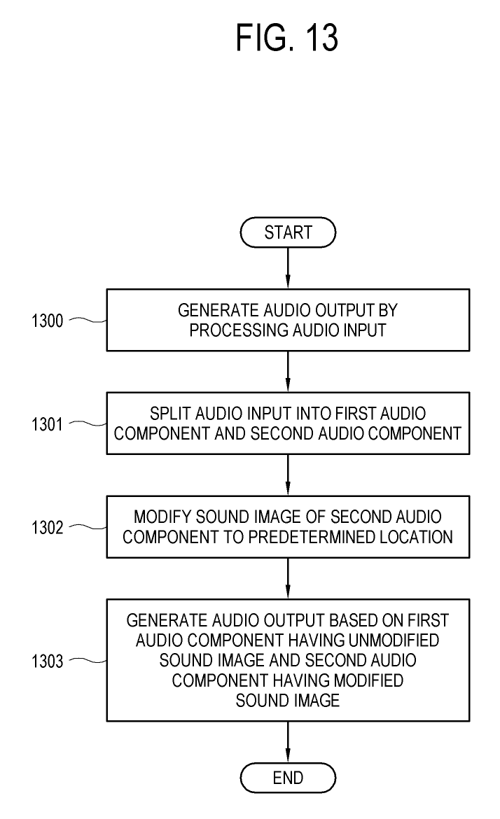

FIG. 13 is a control flowchart according to an exemplary embodiment.

At operation S1300, the controller 205 controls the audio processor 201 to process an audio input and generate an audio output. At operation S1301, the controller 205 controls the audio processor 201 to split the audio input into a first audio component and a second audio component. Then, the controller 205 controls the audio processor 201 to modify a sound image of the second audio component to a predetermined location. Last, the controller 205 controls the audio processor 201 to generate the audio output based on the first audio component and the second audio component modified in the sound image. The method of FIG. 13 may be embodied on a non-transitory computer readable storage medium for controlling a computer according to the method.

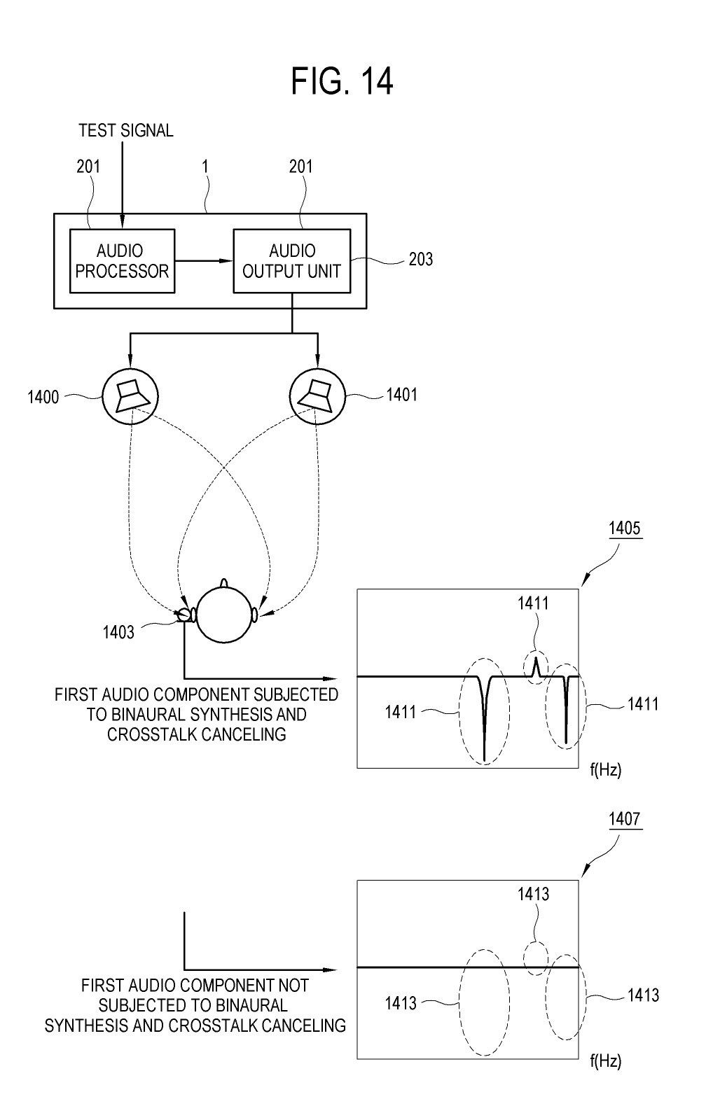

FIG. 14 illustrates improvement in a distortion of an audio output according to an exemplary embodiment. The electronic apparatus 1 may generate a test signal for sensing a distortion of an audio output, and output the test signal after applying an audio process. The electronic apparatus 1 may receive the test signal from the outside. The test signal includes an audio input having at least two channels. The audio processor 201 processes the received test signal and provides the processed test signal to the audio output unit 203. The audio output unit 203 outputs a sound through left and right loudspeakers 1400 and 1401. Using a sensor 1403 positioned at a user's eye or body dummy, it is possible to sense the distortion of the audio output. Since the sound image of the first audio component Center is located at the center, there is a distortion when the binaural synthesis and the crosstalk canceling are applied to the first audio component Center.

The reference numeral of ‘1405’ shows a frequency characteristic of an audio output sensed when the binaural synthesis and the crosstalk canceling are applied to the audio input without splitting the audio component. As the binaural synthesis and the crosstalk canceling are applied to the first audio component Center, the output audio component has distortions 1411 at specific frequencies. The reference numeral of ‘1407’ shows a frequency characteristic of an audio output sensed when the binaural synthesis and the crosstalk canceling are applied to only the second audio components Amb L and Amb R among the first audio component Center and the second audio components Amb L and Amb R are split from the audio input. Since the first audio component Center is separated and thus not subjected to the binaural synthesis and the crosstalk canceling, the output audio component has improvements 1413 in distortions at the specific frequencies.

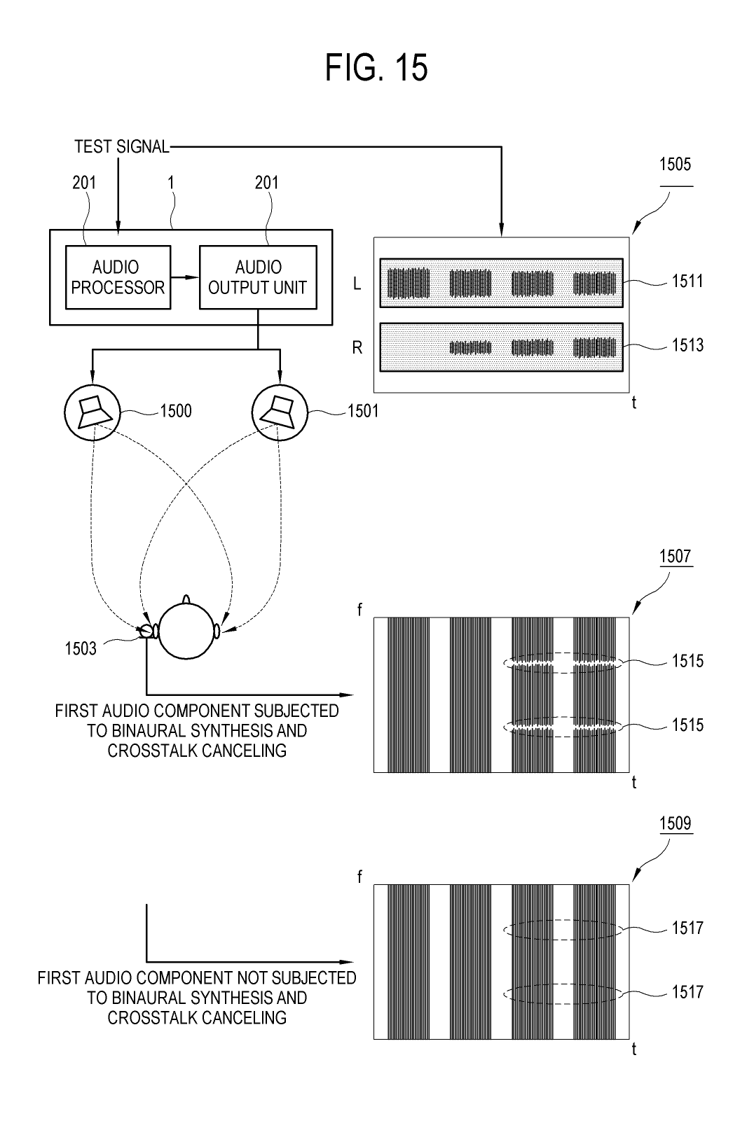

FIG. 15 illustrates improvement in a distortion of an audio output according to an exemplary embodiment, when a test signal is panned from a side to a center. The electronic apparatus 1 may generate a test signal for sensing a distortion of an audio output, and output the test signal after applying an audio process. The electronic apparatus 1 may receive the test signal from the outside. The test signal includes an audio input having at least two channels. The audio processor 201 processes the received test signal and provides the processed test signal to the audio output unit 203. The audio output unit 203 outputs a sound through left and right loudspeakers 1500 and 1501. Using a sensor 1503 positioned at a user's eye or body dummy, it is possible to sense the distortion of the audio output. A test signal 1505 may be a correlated white noise including left and right channels. The test signal 1505 is panned from the left to the center since the levels of the left channel L 1511 and the right channel R 1513 are adjusted as time goes on. Ultimately, a signal having the same level in the left channel 1511 and the right channel 1513 is reproduced so that the sound image can be oriented to the center. The first audio component Center is distorted when the sound image is located at the center and subjected to the binaural synthesis and the crosstalk canceling.

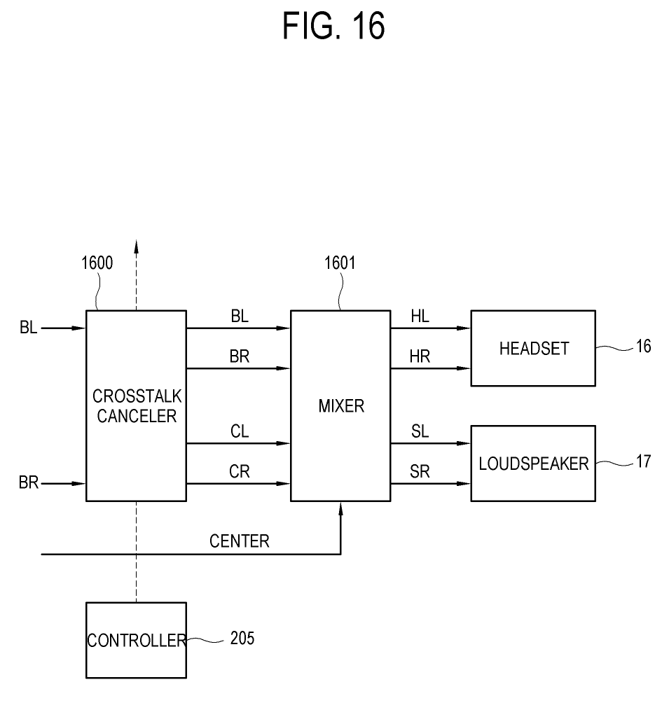

The reference numeral of ‘1507’ shows a frequency characteristic of an audio output sensed when the binaural synthesis and the crosstalk canceling are applied to the audio input without splitting the audio component. As the test signal is panned toward the center, the first audio component Center subjected to the binaural synthesis and the crosstalk canceling has a higher percentage in the audio output. When the test signal is panned toward the center, the output audio component has distortions 1515 at specific frequencies. The reference numeral of ‘1509’ shows a frequency characteristic of an audio output sensed when the binaural synthesis and the crosstalk canceling are applied to only the second audio components Amb L and Amb R among the first audio component Center and the second audio components Amb L and Amb R are split from the audio input. Since the first audio component Center is separated and thus not subjected to the binaural synthesis and the crosstalk canceling, the output audio component has improvements 1517 in distortions at the specific frequencies even though the test signal is panned toward the center. FIG. 16 is a block diagram of an electronic apparatus according to another exemplary embodiment. The electronic apparatus 1 according to an exemplary embodiment may employ not only a loudspeaker 17 but also a headset 16 to output a sound. If the headset 16 is used to output a sound, there is no need of the crosstalk cancelling since one channel sound L and the other channel sound R are not interfered with each other and thus a listener is not hindered from listening the sound. The controller 205 controls a crosstalk canceler 1600 to selectively apply the crosstalk canceling to the binaural synthesized second audio components BL and BR in accordance with whether the sound is output through the headset 16 or the loudspeaker 17. Under control of the controller 205, the crosstalk canceler 1600 outputs the second audio components CL and CR subjected to the crosstalk canceling or the second audio components BL and BR not subjected to the crosstalk canceling to the mixer 1601. The mixer 1601 mixes the second audio components CL and CR subjected to the crosstalk canceling or the second audio components BL and BR not subjected to the crosstalk canceling with the first audio component Center, thereby generating and outputting the loudspeaker audio outputs SL and SR to the loudspeaker 17 or the headset audio outputs HL and HR to the headset 16.

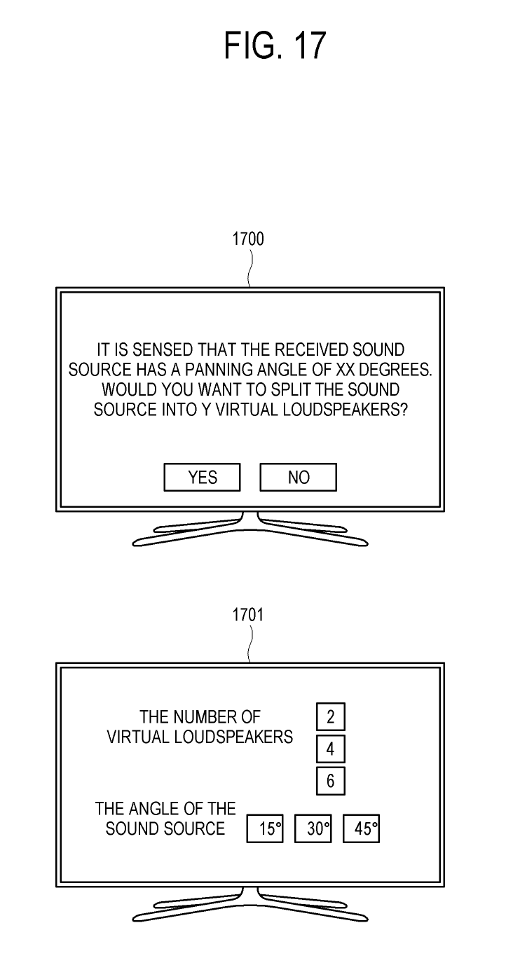

FIG. 17 illustrates an operation of the electronic apparatus according to an exemplary embodiment. The electronic apparatus 1 may adjust the number of virtual loudspeakers and an angle of the sound source in accordance with how much the sound source is panned. For example, the electronic apparatus 1 increases the number of virtual loudspeakers if an audio input is concerned with an orchestra, a stadium or the like where presence is important, or if a large sound image is required with various angles of the sound source. On the other hand, the electronic apparatus 1 decreases the number of virtual loudspeakers if an audio input is concerned with a sound image located at the center like a line of an actor, etc. that is, if the first audio component Center has a high percentage. The reference numeral of ‘1700’ shows an example where the number of virtual loudspeakers is determined based on a panning angle of the sound source in the audio input, and then guided to a user.

Alternatively, the electronic apparatus 1 may determine the number of virtual loudspeakers and the angle of the sound source in accordance with a user's selection. The reference numeral of ‘1701’ shows an example of a user interface (UI) including items for allowing a user to select the number of virtual loudspeakers and the angle of the sound source.

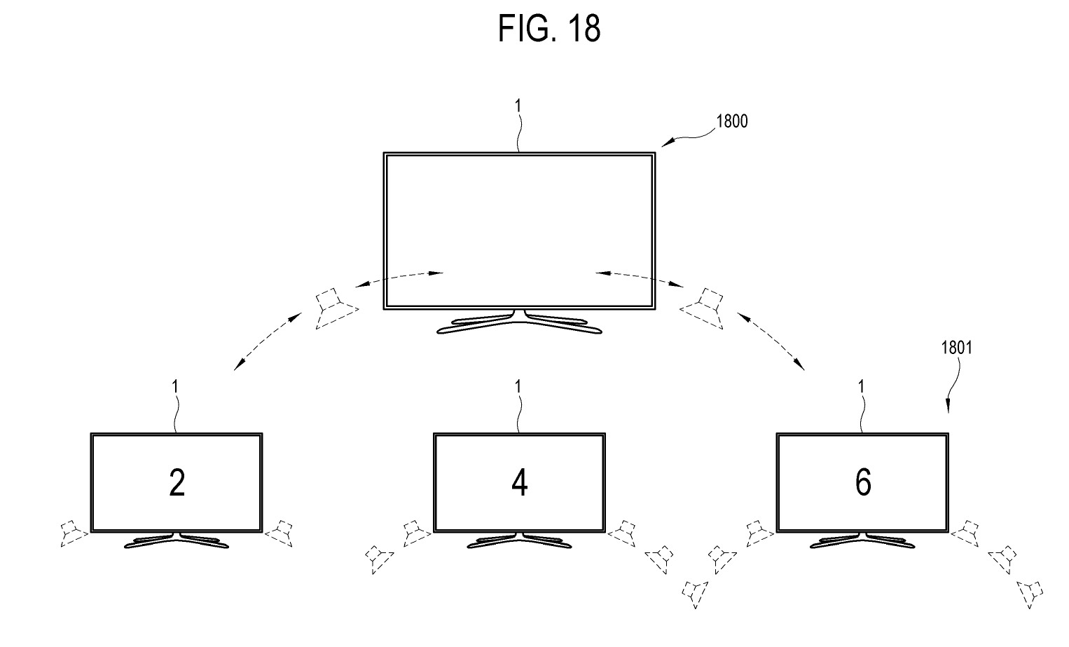

FIG. 18 illustrates an example where the angle of the sound source and the number of virtual loudspeakers determined in FIG. 17 are adjusted according to an exemplary embodiment. The reference numeral of ‘1800’ shows an example where the locations of the virtual loudspeakers are adjusted in accordance with the determined angle of the sound source. The virtual loudspeakers may be generated by application of the HRTF in the binaural synthesizer 301, and the HRTF filter corresponding to the determined angle of the sound source among the plurality of HRTF filters may be applied to the audio input to thereby adjust the locations of the virtual loudspeakers.

The reference numeral of ‘1801’ shows an example where the number of virtual loudspeakers is adjusted. To adjust the number of virtual loudspeakers, the signal splitter 300 splits the second audio components AmbL₁˜AmbL_{N} and AmbR₁˜AmbR_{N} corresponding to the determined number. Then, the binaural synthesizer 301 applies the HRTF filter corresponding to the determined angle of the sound source to the split second audio components AmbL₁˜AmbL_{N} and AmbR₁˜AmbR_{N}, thereby adjusting the number of virtual loudspeakers.

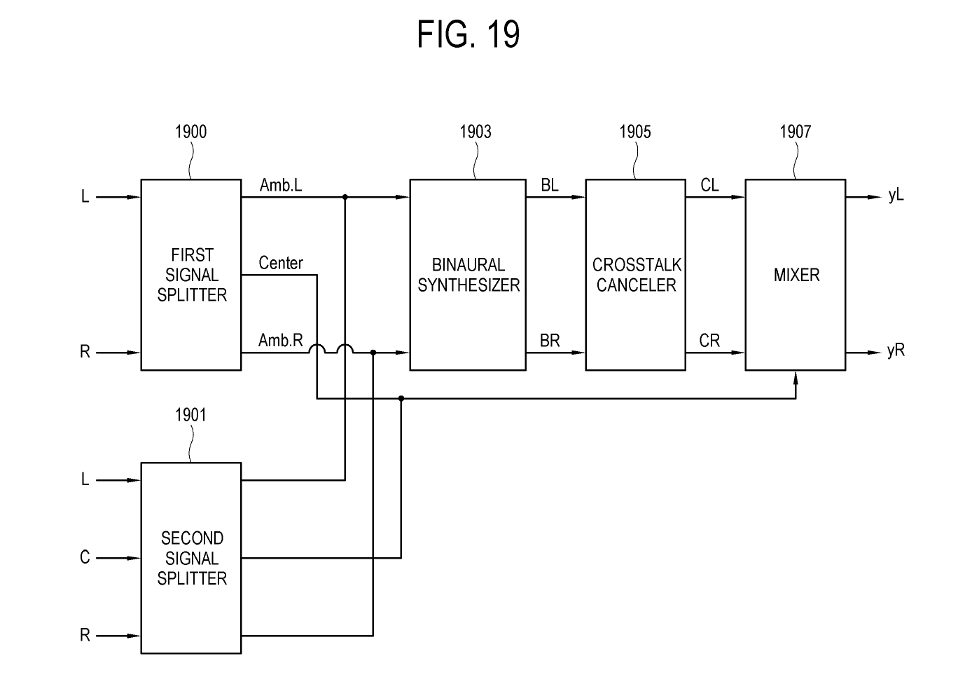

FIG. 19 is a block diagram of an electronic apparatus according to another exemplary embodiment. As described above, an audio input may include two channels of a left channel and a right channel. If the audio input is of two channels, a first signal splitter 1900 splits the audio input into a first audio component Center and second audio components Amb L and Amb R.

The audio input may include three or more channels including a left channel, a right channel and a central channel. In case of the audio input including three or more channels, if the central channel includes a part of the second audio components Amb L and Amb R, the second signal splitter 1901 splits the audio input. For example, if the audio input includes three channels, a correlation coefficient between the left channel and the central channel and a correlation coefficient between the right channel and the central channel are calculated, and then the audio input is split into the first audio component Center having the central sound image and the second audio components Amb L and Amb R having the ambient sound image based on the correlation coefficients. The audio split may be applied even when the audio input includes three or more channels. The second audio components Amb L and Amb R pass through a binaural synthesizer 1903 and a crosstalk canceler 1905 and are then mixed with the first audio component Center in a mixer 1907.

As described above, according to an exemplary embodiment, a sound is reproduced with natural presence since the sound having a larger sound image is provided without an audio distortion.

Although a few exemplary embodiments have been shown and described, it will be appreciated by those skilled in the art that changes may be made in these exemplary embodiments without departing from the principles and spirit of the embodiments, the scope of which is defined in the appended claims and their equivalents.

What is claimed is:

1. An electronic apparatus, comprising:
an audio processor configured to generate an audio output by processing an audio input having at least two channels; and
a controller configured to control the audio processor to split the audio input into a first audio component and a second audio component different in a sound image from each other, modify the sound image of the second audio component to a predetermined location for enhancing presence of the audio output, and generate the audio output based on the first audio component having an unmodified sound image and the second audio component having a modified sound image.

2. The electronic apparatus according to claim 1, wherein the first audio component is concerned with a central sound image, and the second audio component is concerned with an ambient sound image except the central sound image.

3. The electronic apparatus according to claim 1, wherein the controller controls the audio processor to split the second audio component into a plurality of components.

4. The electronic apparatus according to claim 1, further comprising a loudspeaker configured to output a sound based on a generated audio output.

5. The electronic apparatus according to claim 4, wherein the controller controls the audio processor to modify the sound image of the second audio component to a predetermined location based on a position of the loudspeaker.

6. The electronic apparatus according to claim 4, wherein the controller controls the audio processor to perform a process for cancelling crosstalk of sound output through the loudspeaker with regard to the second audio component having the sound image modified to the predetermined location.

7. The electronic apparatus according to claim 1, wherein
a plurality of loudspeakers are arranged to be spaced apart at a predetermined distance from each other based on a frequency band of the audio input, and
the controller controls the audio processor to modify the sound image of the second audio component to a predetermined location based on the predetermined distance and an arranged position of each loudspeaker.

8. A method of controlling an electronic apparatus, the method comprising:
generating an audio output by processing an audio input having at least two channels;
splitting the audio input into a first audio component and a second audio component different in a sound image from each other;
modifying the sound image of the second audio component to a predetermined location; and
generating the audio output based on the first audio component and a modified second audio component.

9. The method according to claim 8, wherein the first audio component is concerned with a central sound image, and the second audio component is concerned with an ambient sound image except the central sound image.

10. The method according to claim 8, wherein the splitting the audio input comprises splitting the second audio component into a plurality of components.

11. The method according to claim 8, further comprising outputting a sound based on a generated audio output through a loudspeaker.

12. The method according to claim 11, wherein the modifying the sound image to a predetermined location comprises modifying the sound image of the second audio component to the predetermined location based on a position of the loudspeaker.

13. The method according to claim 11, further comprising performing a process for cancelling crosstalk of the sound output through the loudspeaker with regard to the second audio component having the sound image modified to the predetermined location.

14. The method according to claim 11, wherein the modifying the sound image to a predetermined position comprises
arranging a plurality of loudspeakers to be spaced apart at a predetermined distance from each other based on a frequency band of the audio input; and
modifying the sound image of the second audio component to a predetermined location based on the predetermined distance and an arranged position of each loudspeaker.

15. A computer program product comprising a computer readable medium having a computer program stored thereon, which, when executed by a computing device, cause the computing device to perform the method of claim 8.

16. The computer program product of claim 15, wherein the computer readable program is stored in the computer readable storage medium in a server and wherein the computer program is downloaded over a network to the computing device.
